(19) United States
(12) Patent Application Publication
(10) Pub. No.: US 2007/0124868 A1
(43) Pub. Date: Jun. 7, 2007

(54) Method for the extraction of keratin from dead animal skins

(75) Inventors: Holger Buehler, Altrip (DE); Joaquim Henrique Teles, Otterstadt (DE); Carsten Suling, Frankenthal (DE); Tilman Ludecke Taeger, Seeheim-Jugenheim (DE); Gunther Pabst, Neumarkt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/579,714

(22) PCT Filed: Nov. 12, 2004
(86) PCT No.: PCT/EP04/12850

§ 371 Date: May 17, 2006

(30) Foreign Application Priority Data
Nov. 17, 2003 (DE) 10353746.5

(51) Int. Cl. C07F 9/22; C07F 9/28

(52) U.S. Cl. 8/94.15; 562/8; 564/9

(57) ABSTRACT

horny substances are removed from hides of dead animals by a process wherein the hides of dead animals are treated with at least one substance of the formula I 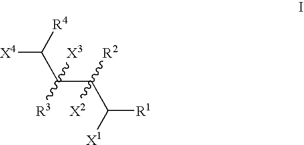 or at least one corresponding alkali metal, alkaline earth metal, ammonium or phosphonium salt, where
R¹ and R⁴ are identical or different and are selected from hydrogen, C₆-C₁₄-aryl and C₁-C₁₂-alkyl, unsubstituted or substituted by one or more SH or OH groups,
R² and R³ are identical or different and are selected from hydrogen, C₆-C₁₄-aryl and C₁-C₁₂-alkyl, unsubstituted or substituted by one or more SH or OH groups,
   at least one radical R² or R³ not being hydrogen
   or R¹ and R⁴ not being hydrogen,
   and it being possible in each case for two vicinal radicals R¹ to R⁴ together to be C₃-C₁₀-alkylene,
R⁵ is selected from hydrogen, C¹-C₁₂-alkyl, H—C═O or C¹-C₄-alkyl-C═O,
X¹, X², X³ and X⁴ are selected from OH, SH and NHR⁵, where,
if R¹ to R⁴ contain at least one sulfur atom, at least one radical X¹ to X⁴ is SH, and, if R¹ to R⁴ contain no sulfur atom, at least two radicals X¹ to X⁴ are SH.

The present invention relates to a process for removing horny substances from hides of dead animals, wherein the hides of dead animals are treated with at least one substance of the formula I 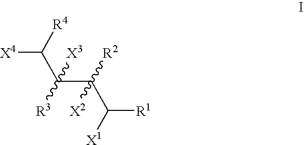
or at least one corresponding alkali metal, alkaline earth metal, ammonium or phosphonium salt,
where
R¹ and R⁴ are identical or different and are selected from hydrogen, C₆-C₁₄-aryl and C₁-C₁₂-alkyl, unsubstituted or substituted by one or more SH or OH groups,
R² and R³ are identical or different and are selected from hydrogen, C₆-C₁₄-aryl and C₁-C₁₂-alkyl, unsubstituted or substituted by one or more SH or OH groups,
   at least one radical R² or R³ not being hydrogen or R¹ and R⁴ not being hydrogen,
   and it being possible in each case for two vicinal radicals R¹ to R⁴ together to be alkylene,
R⁵ is selected from hydrogen, C₁-C₁₂-alkyl, H—C═O or C₁-C₄-alkyl-C═O,
X¹, X², X³ and X⁴ are selected from OH, SH and NHR⁵, where,
if R¹ to R⁴ contain at least one sulfur atom, at least one radical X¹ to X⁴ is SH,
and, if R¹ to R⁴ contain no sulfur atom, at least two radicals X¹ to X⁴ are SH.

Animal hides have been processed for several thousand years to give leather. Before it is possible to begin the-actual leather production, the tanning, the hides must be prepared. These preparation steps generally take place in the beamhouse and include numerous operations. Most of these operations serve for separating off those components of the hides which are undesired in the subsequent leather production or in the subsequent leather. The undesired components also include, as a rule, the hairs together with the hair roots. The unhairing of the hide is usually promoted by chemicals. A distinction is made between oxidative, reductive and enzymatic unhairing methods. An overview of methods is to be found in Herfeld, Bibliothek des Leders, 2, (1988), 62-167, and in E. Heidemann, Fundamentals of Leather Manufacturing, E. Roether K G Druckerei und Verlag, Darmstadt 1993, pages 165-218.

In general, the unhairing of the hide is effected substantially or completely by liming or by painting. Conventional unhairing reagents advantageous in production are Na₂S and NaSH, the latter often also referred to as sodium sulfhydrate. Both salts can usually be used in highly impure form, and industrial Na₂S often has an Na₂S content not exceeding 65% by weight and industrial NaHS usually contains from 70 to 72% of NaHS. However, both Na₂S and NaHS, have disadvantages when used in practice. For safety reasons, Na₂S and NaHS can be used only in a strongly alkaline medium because they evolve toxic and foul-smelling hydrogen sulfide on acidification. The elimination of the unused sulfide, in particular of the sulfide-containing wastewaters, is an unsafe step for ecological reasons and reasons relating to process engineering. If excess sulfide is precipitated, for example with Fe²⁺ or Fe³⁺, iron sulfide sludges which are complicated to separate off are obtained. It is also possible to attempt to convert sulfides into ecologically safe salts by oxidation with, for example, H₂O₂, but corrosion problems have to be accepted.

There has therefore been no lack of attempts to us reagents other than Na₂S or NaHS for the treatment of hides of dead animals. Most attempts start from SH-containing organic reagents.

U.S. Pat. No. 1,973,130 describes the use of numerous organic sulfur compounds, in particular in the presence of lime (column 1, line 40), for unhairing, for example, calfskins. In particular, ethyl mercaptan is a foul-smelling reagent and ethyl mercaptan-containing wastewaters are difficult to work up, which prevents any use in the beamhouse.

FR 1.126.252 describes the unhairing of animal hides by the action of water-soluble thiols, in particular of thioglycolamide (example 1)) and thioglycerol (example 2), in the presence of ammonium sulfate at a pH of 7-8 on animal hides.

Attempts to substitute Na₂S or NaHS by mercaptoacetic acid or mercaptoethanol or the alkali metal or alkaline earth metal salts thereof have, however, not resulted in success because both reagents and also their alkali metal and alkaline earth metal salts readily eliminate hydrogen sulfide and have an extremely unpleasant odor. Furthermore, wastewaters of the beamhouse, comprising mercaptoacetic acid or mercaptoethanol or decomposition and secondary products, are difficult to clarify and give off unpleasant odors.

The use of 1,4-dimercaptobutanediol-containing formulations for removing horny substances, in particular hairs, from living tissue, for example in the case of undesired beard growth, is known from the cosmetic industry. Thus, DE 21 31 630 shows that compositions consisting of at least 0.25% by weight of dimercaptobutanediol and from about 0.01 to 40% by weight of a water-soluble guanidine compound and having a pH of less than 12 can be applied to guinea pigs in order to unhair them, or to human horny skin in order to eliminate calluses without skin irritation in guinea pigs or even erythremia (malignant proliferations of the system for producing the red blood corpuscles) occurring. The epidermis remains intact in the treatment described in DE 21 31 630.

EP-A 0 095 916 discloses the use of formulations comprising aminoethanethiol and 1,4-dimercaptobutanediol and an aminoguanidine or diguanidine compound in order to eliminate undesired human body and facial hair. On page 2, line 1, it is stated that small thiol molecules are preferably suitable for bringing about rapid unhairing because they penetrate more rapidly into the skin. The epidermis remains intact in the treatment described in EP-A 0 095 916.

EP-A 0 096 521 describes the use of formulations comprising, for example, 1,4-dimercaptobutanediol and an aminoguanidine or diguanidine compound for eliminating undesired human body and facial hair. The epidermis remains intact in the treatment described in EP-A 0 096 521.

It is furthermore known that it is possible to modify collagen by virtue of the fact that S-S bridges in the collagen can be opened by reaction with dithioerythrol and subsequent chlorination with chloroacetamide and chloroacetic acid, cf. for example E. Heidemann, Fundamentals of Leather Manufacturing, E. Roether K G Druckerei und Verlag, Darmstadt 1993, page 253. It is also possible to preserve protein solutions by adding dithioerythrol or dithiothreitol. The preservation is based on a type of protection from oxidation, because dithioerythrol is usually oxidized first instead of the protein SH groups.

It is an object of the present invention to provide a process for removing horny substances from hides of dead animals. It is a further object to provide pelts, i.e. hides of dead animals, from which horny substances have been removed. It is a further object to provide compounds with the aid of which horny substances can be removed from hides of dead animals, and a suitable preparation process.

We have found that these objects are achieved by the process defined at the outset.

In the context of the present invention, horny substances are understood as meaning calluses, feathers, nails and claw parts and in particular hairs of animals.

Hides of dead animals, also referred to below as animal hide, may still contain residues of flesh of the relevant dead animals. What is essential to the invention, however, is that they contain horny substances. The amount of horny substance, based on the total weight of the hide or of the fur or of the fur skin, is not critical. The novel process is suitable both for removing large amounts of horny substance and, for example, for removing small hair residues.

Animal hides is understood as meaning at least a whole animal hide or at least a section of a hide of at least one dead animal. Of course, hides or hide pieces of a plurality of dead animals may also be treated according to the invention.

In the context of the present invention, dead animals are understood as meaning not only animals which have been slaughtered or killed in another way but also those animals which have died as a result of accidents, for example traffic accidents or fights with members of the same species or other animals, or as a result of natural causes, such as age or disease.

The hides of dead animals are usually hides of cattle, calves, pigs, goats, sheep, lambs, elks or game, for example stags or roe deer, and furthermore birds, for example ostriches, fish or reptiles, for example snakes.

The following procedure is advantageously adopted for carrying out the novel treatment process.

In the novel process, hides of dead animals are treated with at least one substance of the formula I 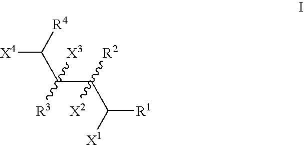
or at least one corresponding alkali metal, alkaline earth metal, ammonium or phosphonium salt,
where
R¹ and R⁴ are identical or different and are selected from
C₆-C₁₄-aryl, such as phenyl, 1-naphthyl, 2-naphthyl, 1-anthryl, 2-anthryl, 9-anthryl, 1 -phenanthryl, 2-phenanthryl, 3-phenanthryl, 4-phenanthryl and 9-phenanthryl, preferably phenyl, 1-naphthyl and 2-naphthyl, particularly preferably phenyl,
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-decyl or n-dodecyl, particularly preferably C₁-C₄-alkyl, such as methyl, ethyl, n-propyl, isopropyl, n-butyl, isobutyl, sec-butyl and tert-butyl;
C₁-C₁₂-alkyl, substituted by one or more hydroxyl or thiol groups, such as hydroxymethyl, 2-hydroxyethyl, 1,2-dihydroxyethyl, 3-hydroxy-n-propyl, 2-hydroxyisopropyl, ω-hydroxy-n-butyl, ω-hydroxy-n-decyl, HS—CH₂—; HS—(CH₂)₂— or HS—(CH₂)₃— and in particular hydrogen.
R² and R³ are identical or different and are selected from
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl,
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-decyl or n-dodecyl, particularly preferably C₁-C₄-alkyl, such as methyl, ethyl, n-propyl, isopropyl, n-butyl, isobutyl, sec-butyl and tert-butyl, very particularly preferably methyl,
C₁-C₁₂-alkyl, substituted by one or more hydroxyl or thiol groups, such as hydroxymethyl, 2-hydroxyethyl, 1,2-dihydroxyethyl, 3-hydroxy-n-propyl, 2-hydroxyisopropyl, ω-hydroxy-n-butyl, ω-hydroxy-n-decyl, HS—CH₂—; HS—(CH₂)₂— or HS—(CH₂)₃—.

At least one radical R² or R³ is not hydrogen, or R¹ and R⁴ are not hydrogen.

In an embodiment of the present invention, R² and R³ are not hydrogen.

In an embodiment of the present invention, R¹, R² and R³ are not hydrogen.

In an embodiment of the present invention, R¹, R², R³ and R⁴ are not hydrogen.

In each case two vicinal radicals R¹ to R⁴ may together be C₃-C₁₀-alkylene, for example —(CH₂)₃—, —(CH₂)₂—CH(CH₃)—, —(CH₂)₂—CH(C₂H₅)—, —(CH₂)₄—, —(CH₂)₅—, —(CH₂)₆—, preferably C₃-C₅-alkylene; in particular —(CH₂)₃—, —(CH₂)₂—CH(CH₃)—, —(CH₂)₂—CH(C₂H₅)—, —(CH₂)₄—, —(CH₂)₅— and form a ring. Thus, it is preferably possible for R¹ and R² together to be —(CH₂)₄— or —(CH₂)₅— with formation of a cyclopentenyl or cyclohexenyl system. It is also possible for R² and R³ together to be a —(CH₂)₄— or —(CH₂)₅— group with formation of an unsubstituted or substituted 1,2-dimethylenecyclopentane system or of an unsubstituted or substituted 1,2-dimethylenecyclohexane system.
R⁵ is selected from hydrogen, C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-decyl or n-dodecyl, particularly preferably C₁-C₄-alkyl, such as methyl, ethyl, n-propyl, isopropyl, n-butyl, isobutyl, sec-butyl and tert-butyl, very particularly preferably methyl,
   or is an H—C═O or C₁-C₄-alkyl-C═O group, for example acetyl, C₂H₅—C═O, n-C₃H₇—C═O, isoC₃H₇—C═O, n-C₄H₉—C═O, isoC₄H₉—C═O, sec-C₄H₉—C═O, tert-C₄H₉—C═O.
X¹, X², X³ and X⁴ are selected from OH, SH and NHR⁵, where if R¹ to R⁴ contain at least one sulfur atom, at least one radical X¹ to X⁴ is SH, and, if R¹ to R⁴ contain no sulfur atom, at least two radicals X¹ to X⁴ are SH.

In particular examples of the novel process, at least one of the compounds 1.1 to 1.9 is used:

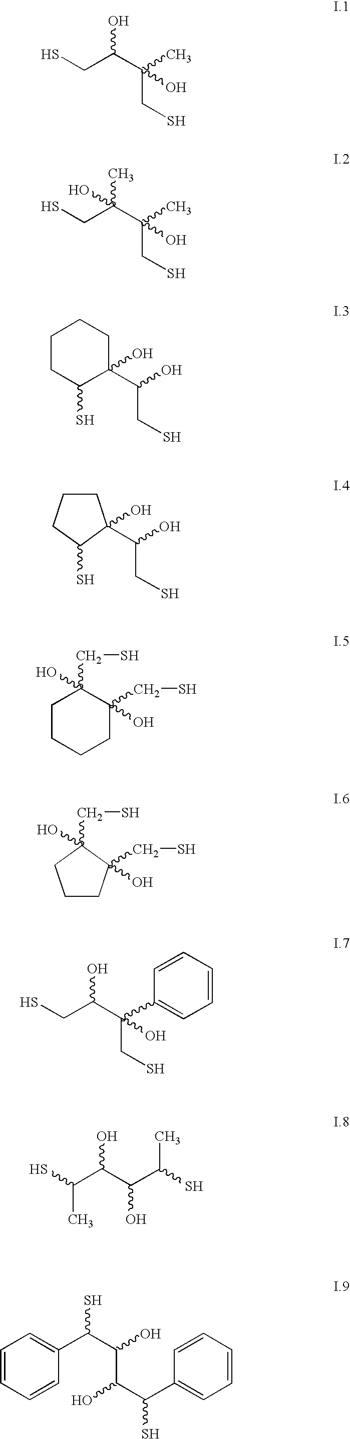

Examples of corresponding alkali metal and alkaline earth metal salts are in particular the mono- and disodium salts, mono- and dipotassium salts and potassium sodium salts of the compounds of the formula I, and furthermore the corresponding calcium and magnesium salts. Examples of corresponding ammonium and phosphonium salts are NH₄⁺ salts and primary, secondary, tertiary and in particular quaternary mono- and diammonium salts and phosphonium salts. Of course, mixtures of compounds of the formula I and the corresponding alkali metal, alkaline earth metal, ammonium or phosphonium salts thereof can also be used.

Preferred mono- and diammonium salts have, as cations, those of the formula N(R⁷)(R⁸)(R⁹)(R¹⁰)⁺, where R⁷ to R¹⁰ are in each case identical or different and are selected from hydrogen, C₁-C₁₂-alkyl, phenyl or CH₂—CH₂—OH. Examples are tetramethylammonium, tetraethylammonium, methyldiethanolammonium and n-butyldiethanolammonium. Preferred mono- and diphosphonium salts have, as cations, those of the formula P(R⁷)(R⁸)(R⁹)(R¹⁰)⁺, where R⁷ to R¹⁰ are as defined above.

In an embodiment of the present invention, X¹ and X⁴ are each SH.

Preferably at least one group X¹ to X⁴ is hydroxyl and particularly preferably at least two groups X¹ to X⁴ are hydroxyl.

In a preferred embodiment of the present invention, the variables are chosen as follows:
R¹ and R⁴ are each hydrogen,
R² is methyl,
R³ is hydrogen or methyl,
X¹ and X⁴ are each SH, and
X² and X³ are each OH.

In general, an amount of from 0.1 to 5, preferably from 0.5 to 2.5, particularly preferably from 0.75 to 1.5, % by weight, based on the hide weight or salted weight of the hide of the dead animal, of at least one compound of the formula I is sufficient.

Preferably, the novel treatment of the animal hide with at least one compound of the formula I is effected during liming or painting, in particular under hair-destroying or under hair-preserving conditions. During liming or painting, instead of the conventional concentration of about 4% by weight of Na₂S or NaHS or even slightly more, it is possible to manage with a concentration of less than 1% by weight of Na₂S or NaHS with the same effect or even a better effect with regard to the removal of horny substances.

In a variant of the novel process, a compound of the formula I is combined with thiols known from tanning, for example mercaptoethanol or thioglycolic acid, during liming. Preferably, less than 0.5% by weight of mercaptethanol or thioglycolic acid is used.

In a very particularly preferred variant of the novel process, however, it is possible to dispense with the use of Na₂S or NaHS or other foul-smelling sulfur-containing reagents.

In an embodiment of the present invention, hides are treated in an aqueous liquor. The liquor ratio may be from 1:10 to 10:1, preferably from 1:2 to 4:1, particularly preferably up to 3:1, based on the hide weight or salted weight of the hides.

In an embodiment of the present invention, the novel process can be carried out at a pH of from 7 to 14, preferably from 8 to 13, particularly preferably from 9 to 12.5.

The pH can be established by adding up to 3% by weight, based on the liquor, of lime (including slaked lime). However, the amount of lime can also be substantially reduced. In a preferred variant of the novel treatment process, the use of lime is dispensed with. In the preferred embodiment, one or more inorganic basic alkali metal compounds are added, for example one or more hydroxides or carbonates of alkali metals, preferably of sodium or potassium, very particularly preferably of sodium. Other suitable inorganic basic alkali metal compounds are alkali metal silicates. It is also possible to add basic amines, for example ammonia, methylamine, dimethylamine, ethylamine or triethylamine, or combinations of alkali metal compounds and one or more basic amines.

In addition to water, further organic solvents may also be present in the liquor, for example up to 20% by volume of ethanol or isopropanol.

The novel process can be carried out in vessels which are customary in the tannery and in which liming is usually effected. Preferably, the novel treatment process is carried out in rotatable drums having baffles. The speed is usually from 0.5 to 100, preferably from 1.5 to 10, particularly preferably up to 4.5, rpm.

The pressure and temperature conditions for carrying out the novel process are generally not critical. The procedure at atmospheric pressure has proven suitable; a pressure increased up to 10 bar is likewise possible. Suitable temperatures are from 10 to 45° C., preferably from 15 to 35° C., particularly preferably from 25 to 30° C.

At least one compound of the formula I can be metered at the beginning of the novel process, but it is also possible first to soak the hide or the hides under basic conditions and to meter at least one novel dithiol mixture only after some time. The metering can be effected in one step, i.e. the total amount of novel dithiol mixture is metered in one step; however, novel dithiol mixture can also be metered a little at a time or continuously.

The novel process can be carried out in a period of from 10 minutes to 48 hours, preferably from 1 to 36 hours, particularly preferably from 3 to 15 hours.

For carrying out the novel process, it is of course also possible to add assistants customary in tanning, for example phosphines, such as triphenylphosphine or tris(2-carboxyethyl)phosphine hydrochloride, and furthermore hydroxylamine, urea, guanidine or guanidine hydrochloride, hydrazine, biocides, enzymes, surfactants and emulsifiers.

By means of the novel process, it is possible to produce pelts which have been unhaired in an excellent manner. Surprisingly, it is found that the epidermis, too, is completely or at least substantially detached after a short duration of treatment.

In an embodiment of the present invention, the novel process is carried out in the presence of at least one enzyme. Exo- and endopeptidases are preferred. These may be members of the main classes of proteases, for example serine proteases, cysteine proteases, metalloproteases and acid proteases.

Examples of serine proteases are trypsin, chymotrypsin, elastase, thrombin, plasmin, subtilisin and acrosin.

Examples of cysteine proteases are papain, bromelain and cathepsin B. Examples of metalloproteases are carboxypeptidase and ACE (angiotensin conversion enzyme).

Examples of acid proteases (aspartate proteases) are pepsin and HIV protease.

Particularly suitable in the context of the present invention are serine proteases, for example trypsin, chymotrypsin, subtilisin and proteinase K and variants of the abovementioned enzymes. Variants include, inter alia, mutants which are formed as a result of insertion(s), deletion(s) and point mutation(s) and have altered, in particular advantageous, properties compared with the protease which was used as starting material in each case. Examples of altered properties are thermal stability, higher affinity to the animal hide (substrate) to be enzymatically converted, (higher) substrate specificity and a shift of the optimum pH into the desired pH range. In the context of the present invention, fragments of abovementioned protease are also referred to as variants. The preparation of variants is effected by a recombinant method by the conventional methods, for example described in Molecular Cloning—A Laboratory Manual by Sambrook, Fritsch and Maniatis (1989), in a suitable bacterial or fungal host system. Very particularly preferred are proteases of the four main classes (serine proteases, cysteine proteases, metalloproteases and acid proteases) having a specific keratinolytic activity and mixtures of these enzymes. In the context of the present invention, enzymes which hydrolyze peptide bonds are also to be understood as meaning commercially available enzyme formulations. Examples of such products are Alcalase 3.0t, Pyrase 250 MP, concentrated PTN 3.0 (type p) from Novozymes, Prozym 6 from TFL, pancreatin from Nordmark A, Pancreatina enzyme PEC from Scientific Protein Laboratory, Alprolase 3m, Basozym® L10 and Basozym® S20 from BASF Aktiengesellschaft, Batinase (manufacturer: Genencor), Proleather (manufacturer: Amano), Protease L 660 (manufacturer: Genencor), Esperase, Alcalas 2.4L and Savinase (manufacturer: Novo Nordisk), and Pruafect 4000L from Genencor.

If one or more abovementioned enzymes or variants of these enzymes are used alone or as mixtures in the novel process, not only is particularly good removal of horny substances achieved but also substantial or preferably complete degradation of the epidermis and substantial removal of melamine are observed.

The amount of enzyme used is usually expressed in Löhlein-Volhard units (LVUs). Usually, instead of pure enzyme, dilute formulations which may be solid or liquid are metered.

The determination of the LVUs is effected by titrimetric methods which are known per se and which are based on the degradation of casein by an enzyme formulation to be investigated or an enzyme to be investigated and subsequent titration of the liberated carboxyl groups with 0.1 N NaOH.

One LVU is equivalent to 0.00575 ml of 0.1 N NaOH.

According to the invention, from 500 to 2 000 000, preferably from 1 000 to 50 000, particularly preferably from 1 500 to 10 000, LVU/kg, based in each case on the salted weight or green weight of the animal hide to be treated, are metered.

The enzyme or enzymes is or are used as a rule within concentrations which are a factor of 10, preferably 100, particularly preferably 1 000, smaller than the amount of compound I.

If one or more enzymes are used, instead of the pure enzyme usually one or more solid or liquid enzyme-containing formulations are metered.

In addition to enzyme, solid formulations also contain inorganic or organic solids or mixtures thereof. Examples of inorganic solids are NaCl, Na₂SO₄, kieselguhr, NaHCO₃, Na₂CO₃ or kaolin, bentonites, clay minerals; suitable organic solids are, for example, polysaccharides, such as starch or modified starch, or urea. Solid formulations may furthermore contain reducing substances, for example NaHSO₃. Liquid formulations contain at least one liquid solvent or dispersant, for example water or mixtures of water and organic solvents.

It has furthermore been found that pelts produced by the novel process are very suitable for the production of leather. After pelts produced by the novel process have been further processed by methods customary in the tannery, i.e. bated, if appropriate delimed, pickled, subjected to chromium-free tanning or chrome tanning, retanned and finished, it is observed that pelts produced by the novel process can be further processed to give leather having an improved area yield and less damage due to swelling in comparison with leather which is produced from pelts which were unhaired with the aid of, for example, Na₂S, NHS, thioglycolic acid or aminoethanol. The present invention therefore furthermore relates to pelts which are obtainable by the novel process.

The present invention furthermore relates to compounds of the formula I 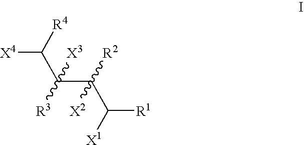
where
R¹ and R⁴ are identical or different and are selected from
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl,
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-decyl or n-dodecyl, particularly preferably C₁-C₄-alkyl, such as methyl, ethyl, n-propyl, isopropyl, n-butyl, isobutyl, sec-butyl and tert-butyl;
C₁-C₁₂-alkyl, substituted by one or more hydroxyl or thiol groups, such as hydroxymethyl, 2-hydroxyethyl, 1,2-dihydroxyethyl, 3-hydroxy-n-propyl, 2-hydroxyisopropyl, ω-hydroxy-n-butyl, ω-hydroxy-n-decyl, HS—CH₂—; HS—(CH₂)₂— or HS—(CH₂)₃—
   and in particular hydrogen.
R² and R³ are identical or different and are selected from
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl,
C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-decyl or n-dodecyl, particularly preferably C₁-C₄-alkyl, such as methyl, ethyl, n-propyl, isopropyl, n-butyl, isobutyl, sec-butyl and tert-butyl, very particularly preferably methyl,
C₁-C₁₂-alkyl, substituted by one or more hydroxyl or thiol groups, such as hydroxymethyl, 2-hydroxyethyl, 1,2-dihydroxyethyl, 3-hydroxy-n-propyl, 2-hydroxyisopropyl, ω-hydroxy-n-butyl, ω-hydroxy-n-decyl, HS—CH₂—; HS—(CH₂)₂— or HS—(CH₂)₃—.

At least one radical R² or R³ is not hydrogen, or R¹ and R⁴ are not hydrogen.

In an embodiment of the present invention, R² and R³ are not hydrogen.

In an embodiment of the present invention, R¹, R² and R³ are not hydrogen.

In an embodiment of the present invention, R¹, R², R³ and R⁴ are not hydrogen.

In each case two vicinal radicals R¹ to R⁴ may together be alkylene, substituted or unsubstituted, preferably C₃-C₁₀-alkylene, for example —(CH₂)₃—, —(CH₂)₂—CH(CH₃)—, —(CH₂)₂—CH(C₂H₅)—, —(CH₂)₄—, —(CH₂)₅—, —(CH₂)₆—, preferably C₃-C₅-alkylene; in particular —(CH₂)₃—, —(CH₂)₂—CH(CH₃)—, —(CH₂)₂—CH(C₂H₅)—, —(CH₂)₄—, —(CH₂)₅—. If two vicinal radicals
R¹ to R⁴ together are alkylene, they form a ring. Thus, it is possible for R¹ and R² together to be —(CH₂)₄— or —(CH₂)₅— with formation of a cyclopentenyl or cyclohexenyl system. It is also possible for R² and R³ together to be a —(CH₂)₄— or —(CH₂)₅— group with formation of an unsubstituted or substituted 1,2-dimethylenecyclopentane system or an unsubstituted or substituted 1,2-dimethylenecyclohexane system.
R⁵ is selected from hydrogen, C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-decyl or n-dodecyl, particularly preferably C₁-C₄-alkyl, such as methyl, ethyl, n-propyl, isopropyl, n-butyl, isobutyl, sec-butyl and tert-butyl, very particularly preferably methyl, or is H—C═O or a C₁-C₄-alkyl-C═O group, for example acetyl, C₂H₅—C═O, n-C₃H₇—C═O, isoC₃H₇—C═O, n-C₄H₉—C═O, isoC₄H₉—C═O, sec-C₄H₉—C═O, tert-C₄H₉—C═O.
X¹, X², X³ and X⁴ are selected from OH, SH and NHR⁵, where, if R¹ to R⁴ contain at least one sulfur atom, at least one radical X¹ to X⁴ is SH, and, if R¹ to R⁴ contain no sulfur atom, at least two radicals X¹ to X⁴ are SH.

Examples of corresponding alkali metal and alkaline earth metal salts are in particular the mono- and disodium salts, mono- and dipotassium salts and potassium sodium salts of compounds of the formula I, and furthermore the corresponding calcium and magnesium salts. Ammonium salts or primary, secondary, tertiary and in particular quaternary mono- and diammonium salts and phosphonium salts may also be mentioned. Mixtures of compounds of the formula I and the corresponding alkali metal or alkaline earth metal salts or ammonium or phosphonium salts thereof can of course also be used.

Preferred mono- and diammonium salts have, as cations, those of the formula N(R⁷)(R⁸)(R⁹)(R¹⁰)⁺, where R⁷ to R¹⁰ are in each case identical or different and are selected from hydrogen, C₁-C₁₂-alkyl, phenyl or CH₂—CH₂—OH. Examples are tetramethylammonium, tetraethylammonium, methyldiethanolammonium and n-butyldiethanolammonium. Preferred mono- and diphosphonium salts have, as cations, those of the formula P(R⁷)(R⁸)(R⁹)(R¹⁰)⁺, where R⁷ to R¹⁰ are as defined above.

In an embodiment of the present invention, X¹ and X⁴ are each SH.

Preferably at least one group X¹ to X⁴ is hydroxyl and particularly preferably at least two groups X¹ to X⁴ are hydroxyl.

Particular examples of novel compounds of the formula I are the compounds of the formulae 1.1 to 1.9

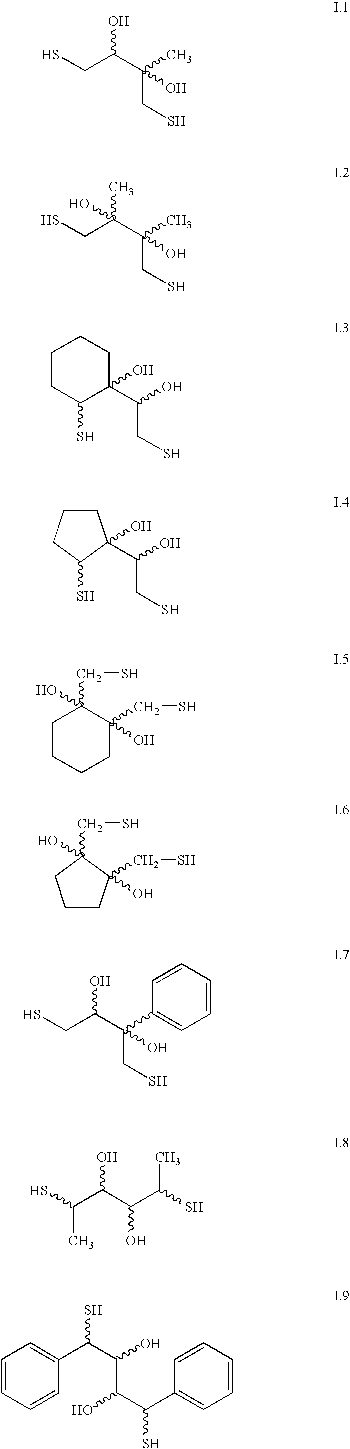

In a preferred embodiment of the present invention, the variables in formula I are chosen as follows:
R¹ and R⁴ are each hydrogen,
R² is methyl,
R³ is hydrogen or methyl,
X¹ and X⁴ are each SH, and
X² and X³ are each OH.

The present invention furthermore relates to a process for the preparation of novel compounds of the formula I, also referred to below as novel preparation process. For carrying out the novel preparation process, a conjugated diene of the formula II

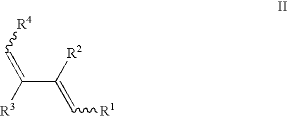

in which the variables are as defined above,

is used as starting material

and is reacted, in a first

stage (a), in the presence of a catalyst, with at least one peroxide to give the

bisepoxide. In a second

stage (b), the bisepoxide is then reacted, in the presence of at least one basic catalyst,

with at least one nucleophile.

Preferred conjugated dienes of the formula II are dienes of the formulae II.1 to II.9

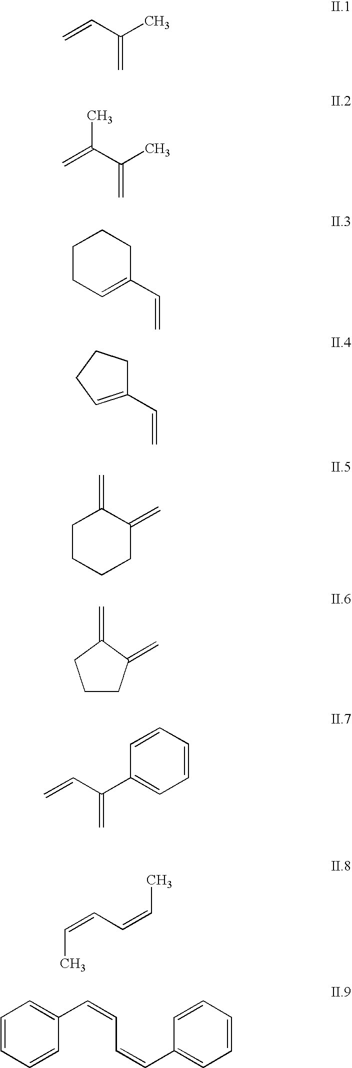

It is possible to isolate and to purify the bisepoxide from stage (a). In a preferred embodiment, however, the isolation of bisepoxide from stage (a) is dispensed with and step (b) is carried out.

Of course, mixtures of olefins or dienes which contain a conjugated diene of the formula II may also be reacted.

According to the invention, the reaction stage (a) is effected in the presence of a catalyst which is obtainable by bringing at least one manganese compound, selected from A₂Mn(Y¹)₄, AMn(Y¹)₃, MnY², Mn(Y¹)₂ and Mn(Y¹)₃,

into contact with at least one ligand L of the formula III 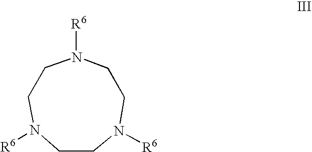
and at least one coligand which is derived from monocarboxylic acids, dibasic or polybasic carboxylic acids or diamines,
where
Y¹ are identical or different and are selected from monovalent anions, R¹²O⁻, F⁻, Cl⁻, Br⁻, I⁻, NCS⁻, N₃⁻, I₃⁻, R¹²COO⁻, R¹²SO₃⁻, R¹²SO₄⁻, OH⁻, CN⁻, OCN⁻, NO₃⁻,ClO₄⁻, PF₆⁻, BPh₄⁻, where Ph=phenyl, and F₃CSO₃⁻. Cl⁻ and acetate are particularly preferred.
Y² is a divalent anion, particularly preferably SO₄²⁻ and HPO₄²⁻.
A are different or preferably identical and are selected from alkali metal cations, for example Li⁺, Na⁺, K⁺, Rb⁺ and Cs⁺, in particular Na⁺ and K⁺,
and ammonium NH₄⁺, which has been alkylated, for example N(R¹³)(R¹⁴)(R¹⁵)(R¹⁶)⁺, where R¹³ to R¹⁶ are in each case identical or different and are selected from hydrogen, benzyl, C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl or n-decyl, particularly preferably C₁-C₄-alkyl, such as methyl, ethyl, n-propyl, isopropyl, n-butyl, isobutyl, sec-butyl und tert-butyl, phenyl or CH₂—CH₂—OH. Examples are tetramethylammonium, tetraethylammonium, methyldiethanolammonium and n-butyldiethanolammonium.
R⁶ are different or preferably identical and are selected from branched or, preferably, straight-chain C₁-C₂₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-octyl, n-decyl, n-dodecyl, n-tetradecyl, n-hexadecyl, n-octadecyl and n-eicosyl, preferably straight-chain C₁-C₁₂-alkyl, such as methyl, ethyl, n-propyl, n-butyl, n-pentyl, n-hexyl, n-heptyl, n-octyl, n-decyl or n-dodecyl, particularly preferably C₁-C₄-alkyl, such as methyl, ethyl, n-propyl, n-butyl, very particularly preferably methyl.
R¹² is preferably
C₁-C₂₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-octyl, n-decyl, n-dodecyl, n-tetradecyl, n-hexadecyl, n-octadecyl and n-eicosyl, preferably straight-chain C₁-C₁₂-alkyl, such as methyl, ethyl, n-propyl, n-butyl, n-pentyl, n-hexyl, n-heptyl, n-octyl, n-decyl or n-dodecyl, particularly preferably C₁-C₄-alkyl, such as methyl, ethyl, n-propyl, n-butyl, very particularly preferably methyl,
substituted C₁-C₂₀-alkyl, such as ω-cyclohexylpropyl or 2-cyclohexylethyl,
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl, preferably cyclopentyl, cyclohexyl and cycloheptyl,
C₆-C₁₄-aryl, for example phenyl, 1-naphthyl, 2-naphthyl, 1-anthryl, n-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl,
or benzyl.

Particularly preferred examples of manganese compounds used according to the invention are manganese(II) sulfate, manganese(II) acetate, manganese(II) chloride, manganese(II) perchlorate or potassium hexachloromanganate(IV) K₂MnCl₆.

It is possible for manganese compounds used according to the invention to have water of crystallization and/or water of hydration, for example Mn(OAc)_{2.}4 H₂O, MnSO₄.H₂O, Mn(ClO₄)_{2.6} H₂O, MnCl_{2.4} H₂O.

In an embodiment of the present invention, from 0.001 to 0.1, particularly preferably from 0.005 to 0.01, equivalent, based on conjugated diene of the formula II, of manganese compound is used.

In an embodiment of the present invention, from 1 to 5, preferably from 1.1 to 2, equivalents, based on manganese, of ligand L of the formula III are used.

Suitable coligands are those compounds which are derived from monocarboxylic acids, dibasic or polybasic carboxylic acids or diamines, i.e. monocarboxylic acids, dibasic or polybasic carboxylic acids and diamines themselves and, in the case of monocarboxylic acids and dibasic or polybasic carboxylic acids, in particular the corresponding alkali metal salts thereof.

In an embodiment of the present invention, coligands are derived from those monocarboxylic acids or dibasic or polybasic carboxylic acids whose pKₐ or pKₐ¹ in water at 25° C. is less than 7.

In an embodiment of the present invention, coligands are derived from oxalic acid (IV.1), dihydroxyfumaric acid (IV.2), tartaric acid (IV.3), maleic acid (IV.4), squaric acid (IV.5), 2-sulfobenzoic acid (IV.6) and N(p-toluenesulfonyl)glycine (IV.7):

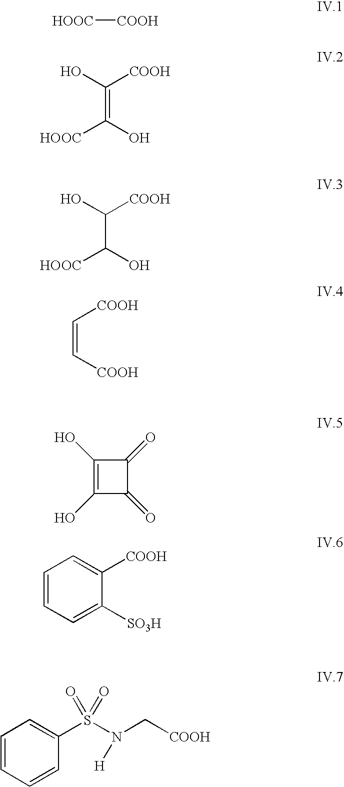

Ascorbic acid is furthermore suitable.

A further very particularly preferred coligand is 1,2-diaminocyclohexane, both the isomer mixture and the respective cis- and trans-isomers in enriched form being suitable.

In an embodiment of the present invention, coligands are used in the form of monocarboxylic acids and alkali metal salt of the relevant monocarboxylic acid.

In an embodiment of the present invention, coligands are used in the form of dibasic or polybasic carboxylic acid and alkali metal salt of the relevant dibasic or polybasic carboxylic acid.

In an embodiment of the present invention, from 0.1 to 5 equivalents, based on manganese, of coligand are used, preferably from 0.5 to 1 equivalent, based on manganese, of coligand is used.

According to the invention, diene of the formula II is reacted with at least one peroxide, preferably up to 4 equivalents of peroxide per equivalent of C—C double bond being used. However, it is also possible to use more peroxide. Particularly preferably, at least one equivalent of peroxide per equivalent of C—C double bond is used. Peroxides which may be used are preferably organic peroxides, in particular tert-butyl hydroperoxide, cumyl hydroperoxide, 1,3-diisopropyl monohydroperoxide or 1-phenylethyl hydroperoxide. Hydrogen peroxide (H₂O₂) is particularly preferred as the peroxide.

If it is desired to use hydrogen peroxide, it is employed as an aqueous solution, for example as a 30 or 50% by weight solution whose content of reactive H₂O₂ can be determined by known methods, for example by titration.

In an embodiment of the present invention, up to 3, preferably up to 2.1, equivalents of peroxide are used per equivalent of C—C double bond.

Several procedures are possible with regard to the sequence in which the reactants of the novel process are brought into contact.

In an embodiment of the present invention, ligand L of the formula III and coligand are first mixed with conjugated diene of the formula II and peroxide, and manganese compound is then added.

In another embodiment of the present invention, ligand L of the formula III is first mixed with coligand and conjugated diene of the formula II and manganese compound, and peroxide is then added.

In another embodiment of the present invention, a complex is first prepared by bringing manganese compound and ligand L and coligand of the formula III into contact with one another and then mixing said complex with conjugated diene of the formula II and then with peroxide.

In another embodiment of the present invention, a complex is first prepared by bringing manganese compound and ligand L of the formula III into contact with one another and then mixing said complex with conjugated diene of the formula II and coligand and then with peroxide.

In another embodiment of the present invention, a complex of the formula [LMn(μ-O)₃MnL]X is first prepared by bringing manganese compound and ligand L of the formula III into contact with one another and then mixing said complex with conjugated diene of the formula II and coligand and then with peroxide.

In another embodiment of the present invention, a complex is first prepared by bringing manganese compound and ligand L and coligand of the formula III into contact with one another and then mixing said complex with conjugated diene of the formula II and then with peroxide, peroxide being added in two portions at a time interval of at least 2 hours.

The form in which the catalytically active species is present is not known exactly. Without wishing to give preference to a theory, it appears conceivable that manganese is present in the oxidation state +IV at least temporarily during the catalytic reaction. Furthermore, it appears possible that singly or multiply μ-oxo-bridged species are present at least temporarily during the catalytic reaction.

In an embodiment of the present invention, the novel process is carried out in a solvent or a mixture of solvents. Solvents which may be used are organic or inorganic liquids which are liquid at reaction temperature and, under the conditions, react only in negligible amounts, if at all, with the reactants and product, i.e. for example bisepoxide.

For example, C₁-C₄-alkanols, such as methanol, ethanol, n-propanol or isopropanol, and furthermore ketones, such as acetone, methyl ethyl ketone and methyl isobutyl ketone (MIBK), acetonitrile, halogenated hydrocarbons, such as methylene chloride, chloroform or 1,1,2,2-tetrachloroethane, and water are suitable. Mixtures of water and acetonitrile, mixtures of water and methanol and mixtures of water and acetone are particularly suitable.

In an embodiment of the present invention, a solvent or a mixture of solvents is used in an amount such that the concentration of bisepoxide does not exceed 50% by weight and is preferably from 5 to 15% by weight.

In an embodiment of the present invention, the novel preparation process is carried out without having immobilized the catalyst beforehand on one or more solid carrier materials, for example silica gel or alumina.

In an embodiment of the present invention, the novel preparation process is carried out at from −50 to 100° C., preferably from −30 to 80° C., particularly preferably from −10 to 60° C., very particularly preferably from 0 to 5° C.

In an embodiment of the present invention, the novel preparation process is carried out at from 1 to 200, preferably from 1 to 100, bar, particularly preferably at from atmospheric pressure to 10 bar.

In an embodiment of the present invention, the novel preparation process is carried out at a pH of from 1 to 7, preferably from 3 to 5.

In an embodiment of the present invention, the duration of the reaction is from 1 minute to 24 hours, preferably from 30 minutes to 20 hours.

Suitable reaction vessels for carrying out the novel preparation process are in principle all conventional reaction vessels, for example tubular reactors and stirred kettles, and stirred kettles can be operated batchwise or continuously and tubular reactors are preferably operated continuously.

The novel preparation process gives solutions of bisepoxide. The solutions of bisepoxide which are obtainable according to the invention may contain small amounts of monoepoxide, for example of the formula V.1 or V.2 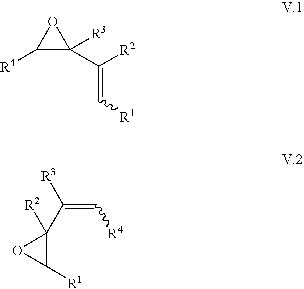
the amount of monoepoxide being, as a rule, less than 10 mol %, based on pure bisepoxide. Bisepoxide can be isolated from solutions obtainable in stage (a) and can be purified.

In a preferred embodiment of the present invention, solutions of bisepoxide which are obtainable by stage (a) described above are used, and isolation and purification operations are dispensed with.

In stage (b), bisepoxide prepared in stage (a) is reacted, in the presence of at least one basic catalyst, with at least one nucleophile.

Suitable nucleophiles are preferably compounds having an atom with at least one free electron pair and at least two acidic hydrogen atoms. For example, H₂S is particularly suitable, and furthermore H₂O and compounds of the formula H₂N—R⁵ where at least one of the radicals R¹ to R⁴ carries SH groups. In a preferred embodiment of the present invention, the nucleophile is H₂S. Of course, mixtures of different nucleophiles may also be used.

In an embodiment, the reaction in stage (b) is preferably effected with from 1 to 10, preferably from 1 to 2, equivalents, based on one equivalent of epoxide group, of nucleophile, preferably with H₂S.

Stage (b) of the novel preparation process is carried out in the presence of at least one basic catalyst.

Suitable basic catalysts are basic alkali metal salts and ammonium salts, for example alkali metal hydroxides, alkali metal carbonates, alkali metal hydrogen sulfides and ammonium hydroxides. Examples of alkali metal cations are Li⁺, Na⁺, K⁺, Rb⁺ and Cs⁺, in particular Na⁺ and K⁺.

Examples of ammonium ions are not only unsubstituted NH₄⁺ but also monoalkylated to tetraalkylated ammonium, for example N(R¹³)(R¹⁴)(R¹⁵)(R¹⁶)⁺, where R¹³ to R¹⁶ are in each case identical or different and are selected from hydrogen, benzyl, C₁-C₁₂-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl or n-decyl, particularly preferably C₁-C₄-alkyl, such as methyl, ethyl, n-propyl, isopropyl, n-butyl, isobutyl, sec-butyl and tert-butyl, phenyl or CH₂—CH₂—OH. Examples are tetramethylammonium, tetraethylammonium, benzyltrimethylammonium, methyldiethanolammonium and n-butyldiethanolammonium.

Preferably, at least one basic catalyst in stage (b) is selected from alkali metal hydrogen sulfide, alkali metal hydroxide and benzyltri(C₁-C₁₀-alkyl)ammonium hydroxide; sodium hydrogen sulfide, potassium hydrogen sulfide, sodium hydroxide, potassium hydroxide and benzyltrimethylammonium hydroxide are very particularly preferred.

In an embodiment of the present invention, from 10⁻⁴ to 10, preferably from 0.5 to 5, % by weight, based on bisepoxide, of basic catalyst are used.

In an embodiment of the present invention, stage (b) is carried out at from 1 to 200, preferably from 1 to 100, particularly preferably from 1 to 10, bar.

In an embodiment of the present invention, stage (b) is carried out at from −50 to 100° C., preferably from −30 to 80° C., particularly preferably from −10 to 60° C., very particularly preferably from 15 to 35° C.

In an embodiment of the present invention, stage (b) of the novel preparation process is carried out at a pH of from 8 to 13, preferably from 9 to 11.

In an embodiment of the present invention, a bisepoxide solution obtainable by stage (a) of the novel process is used as starting material, nucleophile, preferably H₂S is added, at least one basic catalyst is then added and the reaction is allowed to proceed.

In an embodiment of the present invention, further solvent, selected from the solvents mentioned above under stage (a), can be added in stage (b) of the novel two-stage process.

In an embodiment of the present invention, the duration of the reaction is from 10 minutes to 4 hours, particularly preferably from 0.5 hour to 2 hours.

Suitable reaction vessels for carrying out stage (b) of the novel preparation process are in principle all conventional reaction vessels, for example tubular reactors and stirred kettles, and stirred kettles can be operated batchwise or continuously and tubular reactors are preferably operated continuously. Continuously operated stirred kettle cascades are also conceivable as suitable vessels.

Without wishing to give preference to a specific theory, it is conceivable that unreacted peroxide from stage (a) can be trapped by any excess nucleophile, for example H₂S, in stage (b).

By carrying out the novel preparation process, solutions of isomer mixtures or corresponding salts of isomer mixtures, to which the present invention likewise relates, are obtained. From novel solutions of isomer mixtures or of corresponding salts of isomer mixtures, it is possible to isolate novel compound I or its corresponding salts by methods known per se, for example neutralization and distilling off of solvent or solvents. In order to obtain particularly pure novel compound II, distillation may be effected, for example under reduced pressure.

By methods known per se, for example chromatography, isomer mixtures of compound I which are obtainable by the novel preparation process can be separated into erythro- and threo-dithiol, and the enantiomers of threo-dithiol can be separated or concentrated by chiral discrimination.

The present invention relates especially to isomer mixtures of compound VI, comprising

(A) from 55 to 65, preferably from 59 to 61, mol % of erythro-dithiol and

(B) from 35 to 45, preferably from 39 to 41, mol % of threo-dithiol of the formula VI 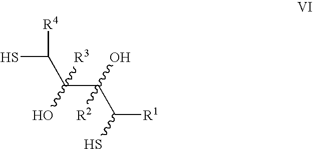
where the variables are defined as above, and corresponding salts of novel isomer mixtures.

Novel isomer mixtures of compound VI contain compounds which, in Fischer projection, may be represented as follows:

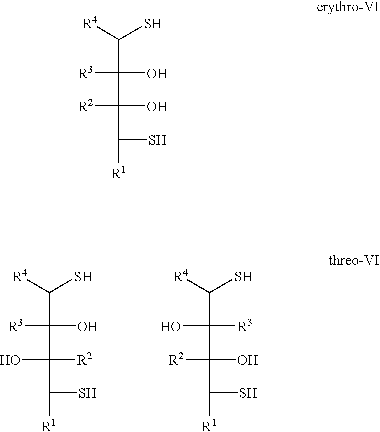

Novel isomer mixtures of compound VI may contain corresponding salts of erythro-VI and threo-VI.

In an embodiment of the present invention, threo-VI is present in the form of a racemate.

Novel isomer mixtures of compound VI may be contaminated with small amounts of hydroxythiol, for example of the formula VII.1 or VII.2 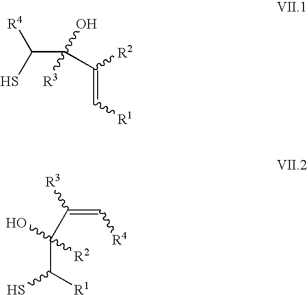
where the amount of hydroxythiol generally does not exceed 10 mol %, based on isomer mixture of compound VI or of corresponding salts of isomer mixtures of compound of the formula VI.

Examples of corresponding salts are in particular the mono- and disodium salts, mono- and dipotassium salts and potassium sodium salts of dithiols of the formula VI, and furthermore the corresponding calcium and magnesium salts. The ammonium salts of primary, secondary, tertiary and in particular quaternary mono- and diammonium salts may also be mentioned.

Preferred mono- and diammonium salts have, as cations, those of the formula N(R¹³)(R¹⁴)(R¹⁵)(R¹⁶)⁺, where R¹³ to R¹⁶ are in each case identical or different and are selected from hydrogen, C₁-C₁₂-alkyl, phenyl or CH₂—CH₂—OH. Tetramethylammonium, tetraethylammonium, methyldiethanolammonium and n-butyldiethanolammonium may be mentioned by way of example.

The present invention furthermore relates to aqueous solutions comprising the novel isomer mixture of the formula VI. Novel aqueous solutions can be obtained, for example, by dissolving a novel isomer mixture or corresponding salt in water. Novel aqueous solutions preferably have a solids content of from 0.1 to 50% by weight.

Working examples which follow illustrate the invention.

1. Preparation of Novel Compound of the Formula I.1

(a) Preparation of Bisepoxide

The following were mixed with one another in a 150 ml glass autoclave having an inlet tube:

42.6 g of acetonitrile,

9 ml of aqueous manganese(III) acetate solution having a concentration of

0.02 mol Mn/l,

9 ml of 1,4,7-trimethyl-1,4,7-triazacyclononane having a concentration of 0.03 mol/l and

9 ml of aqueous sodium oxalate/oxalic acid buffer (molar ratio: 1:1) having a concentration of 0.06 mol/l of oxalate and oxalic acid together.

The solution thus obtainable was cooled to about −40° C. with the aid of a dry ice/acetone bath. 4.20 g (61.8 mmol) of isoprene were then added. A temperature of 0° C. was then established with the aid of an ice bath.

16.7 g of 50% strength by weight aqueous H₂O₂ solution (246 mmol of H₂O₂) were then pumped in in the course of 1 hour, it being ensured that the temperature did not exceed 25° C. It was observed that the pressure in the autoclave increased to 5.2 bar. Thereafter, the ice bath was removed and stirring was continued for 2 hours at room temperature. A pressure of 3.2 bar had been then established.

16.6 g of 50% strength by weight aqueous H₂O₂ solution (244 mmol of H₂O₂) were then pumped in, it being ensured that the temperature did not exceed 25° C. It was observed that the pressure in the autoclave increased to 3.8 bar. Thereafter, the ice bath was removed and stirring was continued for 5.5 hours at room temperature. After 5.5 hours, a pressure of 5 bar had been established.

Thereafter, the pressure had been let down and the composition of the resulting pale solution (94.6 g) was determined by gas chromatography. A content of 58.4 mmol of bisepoxide of the formula VIII.1 was determined.

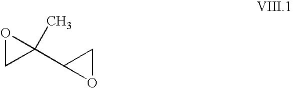

The yield of desired bisepoxide VIII.1was 94.5%.

(a.2)

The reaction of (a.1) was repeated, except that, after 16.7 g of 50% strength by weight aqueous H₂O₂ solution had been pumped in and the ice bath removed, stirring was carried out at room temperature for 12 hours. Further processing was then effected as described under (a.1). Bisepoxide VIII.1 was obtained in very good yield.

(b) Preparation of Novel Compound I.1

50 g of the solution resulting from 1 (a. 1) were initially taken in a 400 ml glass autoclave, and H₂S at 6 bar was forced in at room temperature. The solution of 1.04 g of NaOH (solid) in 20 ml of methanol was then added with the aid of an HPLC pump. During the addition of methanol/NaOH, a temperature increase was observed.

The pressure was kept at 6 bar by continuously forcing in H₂S. The lines of the HPLC pump were then flushed with 50 ml of acetonitrile.

After the end of the reaction, which is evident from a decline in the temperature, the autoclave was let down and was freed from excess H₂S over a period of 14 hours by passing N₂ through the reaction mixture.

A clear solution of isomer mixture of novel compound I.1 was obtained.

Chromatographic methods, for example gas chromatography, are suitable as an analytical and preparative method for separating the isomers. Examples of suitable conditions are:

Column: HP-5 from Hewlett-Packard, length: 30 m, internal diameter=0.25 mm, film thickness 0.25 μm, detector: WLD, init. T.: 40° C., init. time: 5, rate: 10° C./min, final temperature 290° C., retention time IV.1: 18.00-18.50 min.

2. Treatment of Hides with Novel Compound I.1

The values in % by weight are based in each case on the salted weight, unless stated otherwise.

General Pretreatment:

A South German cattle hide is first presoaked with 200% by weight of water and 0.2% by weight of C₁₅H₃₁—O—(CH₂—CH₂—O)₇—H at 28° C. for 10 minutes in a drum with gentle stirring. The liquor is discharged, and soaking is then effected with 100% by weight of water, 0.2% by weight of C₁₅H₃₁—O—(CH₂—CH₂—O)₇—H and 0.5% by weight of Na₂CO₃ with occasional stirring for 19 hours. The liquor is then discharged.

The soaked South German cattle hides are fleshed in the green state (thickness about 4 mm) and the butts of the hides are cut into hide pieces each having a green weight of 2.5 kg.

Below, the values in % by weight are based in each case on the green weight, unless stated otherwise.

2.1. Liming of Comparative Example C2.1

For comparative example C1, 100% by weight, based on green weight, were treated in succession with 60 parts by weight of water, 0.8% by weight of NaSH and 3% by weight of slaked lime in a rotatable 10 l drum containing baffles. 0.75% by weight of sodium sulfide followed at intervals of 30 minutes. The drum was operated for a further 45 minutes at 15 revolutions per minute. A further 40 parts by weight of water were then metered. After 10 hours at from 23 to 27° C. and 5 revolutions per minute, the experiments were stopped by discharging the liquor, and the hides were washed twice for 15 minutes with 150 parts by weight of water.

2.2. Hair-Destroying Liming of Novel Examples 2.2 to 2.5

In novel examples 2.2 to 2.5, in rotatable 10 l drums containing baffles, 60% by weight of water were first added to 100% by weight, based on green weight, which were then treated in succession with products, in each case after elapse of the stated time as shown in table 1.

TABLE 1

| | Amount used | | Time |
|---|---|---|---|
| Example | [% by weight] | Addition of product | [min] |
| 2.2 | 0.5 | Sodium sulfhydrate (70%) | |
| | 0.5 | Compound I.1 | 60 |
| | 1.2 | Slaked lime | 60 |
| | 1.2 | Slaked lime | 60 |
| 2.3 | 1.0 | Compound I.1 | 60 |
| | 1.2 | Slaked lime | 60 |
| | 1.2 | Slaked lime | |
| 2.4 | 1.0 | Compound I.1 | 60 |
| | 1.0 | Aqueous sodium hydroxide solution | 30 |
| | | (50% by weight) | |
| | 1.0 | Aqueous sodium hydroxide solution | 30 |
| | | (50% by weight) | |
| | 50 | Water | |
| | 0.4 | Aqueous sodium hydroxide solution | 60 |
| | | (50% by weight) | |
| | 50 | Water | 30 |
| 2.5 | 1.0 | Compound I.1; | 60 |
| | | papain formulation containing 2 000 | |
| | | LVU/g | |
| | 1.0 | Aqueous sodium hydroxide | 30 |
| | | solution (50% by weight) | |
| | 1.0 | Aqueous sodium hydroxide solution | 30 |
| | | (50% by weight) | |
| | 50 | Water | |
| | 0.4 | Aqueous sodium hydroxide solution | 60 |
| | | (50% by weight) | |
| | 50 | Water | 30 |

Papain formulation is papaya peptidase I, EC 3.4.22.2, a gray-white to pale yellow powder, which is obtained by drying and powdering the latex of unripe papayas.

The drums were operated for a further 45 minutes at 5 revolutions per minute. A further 40% by weight of water were then metered. After 10 minutes at from 23 to 27° C. with periodic operation at 3 revolutions per minute for, in each case, 5 minutes per hour, the experiments were stopped by discharging the liquor, and the pelts obtained were washed twice, for 15 minutes each time, with 150% by weight of water.

2.3. Assessment of Pelts According to Comparative Example and According to Novel Examples After Liming

The pelts treated according to the novel examples were assessed with regard to the swelling, quality of the grain and removal of the epidermis.

1. A process for removing horny substances from hides of dead animals, wherein the hides of dead animals are treated with at least one substance of the formula I 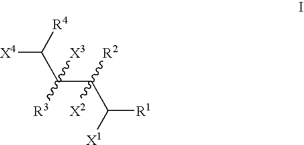
or at least one corresponding alkali metal, alkaline earth metal, ammonium or phosphonium salt,
where
R¹ and R⁴ are identical or different and are selected from hydrogen, C₆-C₁₄-aryl and C₁-C₁₂-alkyl, unsubstituted or substituted by one or more SH or OH groups,
R² and R³ are identical or different and are selected from hydrogen, C₆-C₁₄-aryl and C_{1-C}₁₂-alkyl, unsubstituted or substituted by one or more SH or OH groups,
at least one radical R² or R³ not being hydrogen
or R¹ and R⁴ not being hydrogen,
and it being possible in each case for two vicinal radicals R¹ to R⁴ together to be alkylene,
R⁵ is selected from hydrogen, C₁-C₁₂-alkyl, H—C═O or C₁-C₄-alkyl-C═O,
X¹, X², X³ and X⁴ are selected from OH, SH and NHR⁵, where,
if R¹ to R⁴ contain at least one sulfur atom, at least one radical X¹ to X⁴ is SH,
and, if R¹ to R⁴ contain no sulfur atom, at least two radicals X¹ to X⁴ are SH.

2. A process according to claim 1, which is carried out in aqueous liquor.

3. A process according to claim 1, which is carried out in the presence of basic alkali metal salts.

4. A process according to claim 1, wherein X¹ and X⁴ are each SH.

5. A process according to claim 1, wherein
R¹ and R⁴ are hydrogen,
R² is methyl,
R³ is selected from hydrogen and methyl,
X¹ and X⁴ are each SH and
X² and X³ are each OH.

6. A process according to claim 1, which is carried out in the presence of at least one enzyme.

7. A pelt obtainable by a process according to claim 1.

8. A compound of the formula I 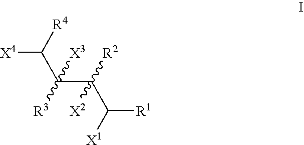
and its corresponding alkali metal, alkaline earth metal, ammonium and phosphonium salts,
where
R¹ and R⁴ are identical or different and are selected from hydrogen, C₆-C₁₄-aryl and C₁-C₁₂-alkyl, unsubstituted or substituted by one or more SH or OH groups,
R² and R³ are identical or different and are selected from hydrogen, C₆-C₁₄-aryl and C₁-C₁₂-alkyl, unsubstituted or substituted by one or more SH or OH groups,
at least one radical R² or R³ not being hydrogen
or R¹ and R⁴ not being hydrogen,
and it being possible in each case for two vicinal radicals R¹ to R⁴ together to be alkylene,
R⁵ is selected from hydrogen, C₁-C₁₂-alkyl, H—C═O or C₁-C₄-alkyl-C═O,
X¹, X², X³ and X⁴ are selected from OH, SH and NHR⁵, where,
if R¹ to R⁴ contain at least one sulfur atom, at least one radical X¹ to X⁴ is SH,
and, if R¹ to R⁴ contain no sulfur atom, at least two radicals X¹ to X⁴ are SH.

9. A compound according to claim 8, wherein X¹ and X⁴ are each SH.

10. A compound according to claim 8, wherein
R¹ and R⁴ are hydrogen,
R² is methyl,
R³ is hydrogen or methyl,
X¹ and X⁴ are each SH and
X² and X³ are each OH.

11. A process for the preparation of compounds of the formula I, wherein
(a) in a first stage, a diene of the formula II 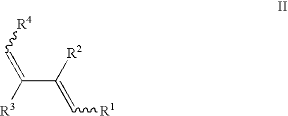
is reacted in the presence of a catalyst which is obtainable by bringing into contact
at least one manganese compound, selected from A₂Mn(Y¹)₄, AMn(Y¹)₃, MnY², Mn(Y¹)₂ and Mn(Y¹)₃
with at least one ligand L of the formula III 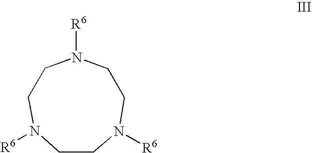
where
Y¹ are identical or different and are selected from monovalent anions,
Y² is a divalent anion,
A is selected from alkali metal and ammonium, which may be alkylated,
R⁶ are identical or different and are selected from C₁-C₂₀-alkyl,
and with at least one coligand which is derived from monocarboxylic acid, dibasic or polybasic carboxylic acids or diamines,
with at least one peroxide to give the bisepoxide,
(b) which is reacted in the presence of at least one basic catalyst with at least one nucleophile.

12. A process according to claim 11, wherein the coligand is oxalate.

13. A process according to claim 11, wherein the nucleophile chosen is H₂S or H₂N-R⁵.

14. A process according to claim 11, wherein at least one basic catalyst in stage (b) is selected from alkali metal hydrogen sulfide, alkali metal hydroxide and benzyltri(C₁-C₁₀-alkyl)ammonium hydroxide.

15. A process according to claim 11, wherein X¹ and X⁴ are each SH.

16. A process according to claim 11, wherein, in formula I, the variables are chosen as follows:
R¹ and R⁴ are hydrogen,
R² is methyl,
R³ is hydrogen or methyl,
X¹ and X⁴ are each SH and
X² and X³ are each OH,
and wherein H₂S is chosen as the nucleophile.
